(19) United States
(12) Patent Application Publication
(10) Pub. No.: US 2012/0207480 A1
(43) Pub. Date: Aug. 16, 2012

(54) OPTICAL SIGNAL CONTROLLING APPARATUS AND METHOD, AND OPTICAL SIGNAL GENERATING DEVICE INCLUDING THE OPTICAL SIGNAL CONTROLLING APPARATUS

(75) Inventors: Jyung Chan LEE, Daejeon (KR); Hwan Seok CHUNG, Daejeon (KR)

(73) Assignee: Electronics and Telecommunications Research Institute, Daejeon (KR)

(21) Appl. No.: 13/359,951

(22) Filed: Jan. 27, 2012

(30) Foreign Application Priority Data
Feb. 10, 2011 (KR) 10-2011-0011798

(51) Int. Cl. H04J 14/08

(52) U.S. Cl. 398/98

(57) ABSTRACT

A control section and a signal detection section of an optical modulator are provided for controlling two interferometers (MZI1 and MZI 2) and a phase shifter (MZI 3) of an optical modulator. The signal detection section detects signals having the same frequency, and the control section of the optical modulator time-divides the detected signal so that a DC bias is optimally adjusted. In addition, a process is divided into an initial operation flow and a repeating operation flow so as to further improve the control efficiency of the optical modulator. An initial state control of the optical modulator and a state control during operations are performed through the respective flows. An optimal DC bias position used to control the optimal modulator is automatically corrected.

### CROSS-REFERENCE TO RELATED APPLICATIONS

This application claims priority to and the benefit of Korean Patent Application No. 10-2011-0011798 filed in the Korean Intellectual Property Office on Feb. 10, 2011, the entire contents of which are incorporated herein by reference.

### TECHNICAL FIELD

The present invention relates to an optical signal controlling apparatus and method, and an optical signal generating device including the optical signal controlling apparatus. In particular, the present invention relates to an optical signal controlling apparatus and method for controlling a Differential Quadrature Phase Shift Keying (DQPSK) optical signal, and an optical signal generating device including the optical signal controlling apparatus.

### BACKGROUND ART

Today, methods for generating high-rate modulated data using light have been diversified. Examples of such methods include Non-Return-to-Zero (NRZ) and Return-to-Zero (NZ) schemes, which change the intensity of optical signals, and Phase Shift Keying (PSK), Differential Phase Shift Keying (DPSK), and Differential Quadrature Phase Shift Keying (DQPSK) modulation schemes, which modulate phases of optical signals. In particular, as a data transmission rate increases, requirements for opto-electronic frequency characteristics also increase. As practical technologies for overcoming the requirements, research and development has been conducted on a variety of modulation methods that may be implemented with opto-electronic or electro-optic devices requiring a relatively low electric signal band, even though a data transmission rate is increased by increasing the number of bits per symbol. A DQPSK scheme, one of the modulation schemes for transmitting data by changing a phase of light, has been widely used for high-rate optical signals and long distance transmission, as compared to NRZ and RZ On-Off Keying (OOK) schemes changing the intensity of optical signals. Even presently, the DQPSK scheme has been continuously researched and developed.

However, a DC bias drift occurs in the MZIs used within the DQPSK optical modulator for generating a DQPSK optical signal. That is, a transfer curve characteristic moves left and right, depending on a variation in ambient temperature. Therefore, in the DQPSK optical modulator for generating a DQPSK optical signal, a transfer characteristic curve with respect to a variation in operating temperature is leading to performance degradation of a transport system. Therefore, there is a need for automatically correcting a DC bias of an optical modulator at an optimal position so as to generate and output a stable optical signal, even though the operating temperature of the optical modulator is changed.

### SUMMARY OF THE INVENTION

The present invention has been made in an effort to provide optical signal controlling apparatus and method for automatically correcting an optimal DC bias position used to control an optical modulator, and an optical signal generating device including the optical signal controlling apparatus.

An exemplary embodiment of the present invention provides an optical signal controlling apparatus, including: a bias signal generating unit configured to generate bias signals complying with a predefined reference by using an acquisition signal acquired from a detected optical signal; a time-division signal generating unit configured to generate as many time-division signals as the generated bias signals; and an optical signal control unit configured to combine the mutually corresponding bias signals and time-division signals among the generated bias signals and the generated time-division signals, respectively, change a phase value using the combined signals, and control an optical signal to be output.

The optical signal control unit may control the optical signal by controlling an optical modulator, which includes a first interferometer configured to generate a first channel signal, a second interferometer configured to generate a second channel signal, and a third interferometer configured to generate a constant phase difference between the first channel signal and the second channel signal. When the control for the optical modulator is the first time, the optical signal control unit may alternately control the first interferometer and the second interferometer and then control the third interferometer. When the control for the optical modulator is not the first time, the optical signal control unit may sequentially control the first to third interferometers.

The optical signal controlling apparatus may further include: an optical signal amplifying unit configured to amplify the detected optical signal; a first signal extracting unit configured to extract a signal of a predefined first band from the amplified optical signal; a first signal processing unit configured to generate a bias signal from the extracted signal of the first band, and provide the generated bias signal as the acquisition signal; and a second signal processing unit configured to extract a signal of a second band, a frequency of which is lower than a frequency of the first band, from the amplified optical signal, and provide the extracted signal of the second band as the acquisition signal.

The time-division signal generating unit may include: a monitor signal generating unit configured to generate a monitor signal for controlling interferometers provided in an optical modulator; and a signal splitting unit configured to split the generated monitor signal into as many time-division signals as the interferometers.

The time-division signal generating unit may generate the time-division signals using a transfer curve of an optical modulator that generates the optical signal. The optical signal control unit may include: a first determining unit configured to determine whether the optical modulator is data-write-enabled; a bias value acquiring unit configured to acquire a first bias value from a bias signal selected among the generated bias signals, when the optical modulator is data-write-enabled; a second determining unit configured to determine whether the acquired first bias value is equal to a predefined target value; a first bias value generating unit configured to generate a second bias value greater than the acquired first bias value, when the acquired first bias value is not equal to the target value; a third determining unit configured to determine whether the generated second bias value is located on the left of a null position in the transfer curve; a fourth determining unit configured to increase the second bias value until the second bias value is located on the left of the null position, when the generated second bias value is not located on the left of the null position, and to determine whether the second bias value is equal to the target value, when the generated second bias value is located on the left of the null position; a second bias value generating unit configured to generate a third bias value less than the second bias value, when the second bias value is not equal to the target value; a fifth determining unit configured to determine whether the generated third bias value is located on the left of a quad-minus (quad−) position in the transfer curve; and a reference providing unit configured to decrease the third bias value until the third bias value is located on the left of the quad− position, when the generated third bias value is not located on the left of the quad− position in the transfer curve, and to provide the third bias value as a predefined reference, when the generated third bias value is located on the left of the quad− position.

Another exemplary embodiment of the present invention provides an optical signal controlling method, including: a bias signal generating step for generating bias signals complying with a predefined reference using an acquisition signal acquired from a detected optical signal; a time-division signal generating step for generating as many time-division signals as the generated bias signals; and an optical signal controlling step for combining the mutually corresponding bias signals and time-division signals among the generated bias signals and the generated time-division signals, respectively, changing a phase value using the combined signals, and controlling an optical signal to be output.

The optical signal controlling step may include controlling the optical signal by controlling an optical modulator, which includes a first interferometer configured to generate a first channel signal, a second interferometer configured to generate a second channel signal, and a third interferometer configured to generate a constant phase difference between the first channel signal and the second channel signal. When the control for the optical modulator is the first time, the optical signal controlling step may include alternately controlling the first interferometer and the second interferometer and then controlling the third interferometer. When the control for the optical modulator is not the first time, the optical signal controlling step may include sequentially controlling the first to third interferometers.

The optical signal controlling method may further include: an optical signal amplifying step for amplifying a detected optical signal; a first signal extracting step for extracting a signal of a predefined first band from the amplified optical signal; a first signal processing step for generating a bias signal from the extracted signal of the first band, and providing the generated bias signal as the acquisition signal; and a second signal processing step for extracting a signal of a second band, a frequency of which is lower than a frequency of the first band, from the amplified optical signal, and providing the extracted signal of the second band as the acquisition signal.

The time-division signal generating step may include: a monitor signal generating step for generating a monitor signal for controlling interferometers provided in an optical modulator; and a signal splitting step for splitting the generated monitor signal into as many time-division signals as the interferometers.

In the time-division signal generating step, the time-division signals may be generated using a transfer curve of an optical modulator that generates an optical signal. The optical signal controlling step may include: a first determining step for determining whether the optical modulator is data-write-enabled; a bias value acquiring step for acquiring a first bias value from a bias signal selected among the generated bias signals, when the optical modulator is data-write-enabled; a second determining step for determining whether the acquired first bias value is equal to a predefined target value; a first bias value generating step for generating a second bias value greater than the acquired first bias value, when the acquired first bias value is not equal to the target value; a third determining step for determining whether the generated second bias value is located on the left of a null position in the transfer curve; a fourth determining step for increasing the second bias value until the second bias value is located on the left of the null position, when the generated second bias value is not located on the left of the null position, and determining whether the second bias value is equal to the target value, when the generated second bias value is located on the left of the null position; a second bias value generating step for generating a third bias value less than the second bias value, when the second bias value is not equal to the target value; a fifth determining step for determining whether the generated third bias value is located on the left of a quad-minus (quad−) position in the transfer curve; and a reference providing step for decreasing the third bias value until the third bias value is located on the left of the quad− position, when the generated third bias value is not located on the left of the quad− position in the transfer curve, and providing the third bias value as a predefined reference, when the generated third bias value is located on the left of the quad− position.

Yet another exemplary embodiment of the present invention provides an optical signal generating device, including: a data generating unit configured to generate a third channel signal and a fourth channel signal; an optical modulation unit configured to generate an optical signal for incident light, considering the generated third channel signal and the generated fourth channel signal, and to output the generated optical signal to the exterior; an optical detection unit provided in the optical modulation unit and configured to detect the generated optical signal; a bias signal generating unit configured to generate bias signals complying with a predefined reference by using an acquisition signal that is acquired from the detected optical signal; a time-division signal generating unit configured to generate as many time-division signals as the generated bias signals; and an optical signal control unit configured to combine the mutually corresponding bias signals and time-division signals among the generated bias signals and the generated time-division signals, respectively, change a phase value using the combined signals, and control an optical signal to be output.

The optical modulation unit may interwork with the optical signal control unit to generate and output a Differential Quadrature Phase Shift Keying (DQPSK) optical signal.

The optical signal control unit may control the optical signal by controlling an optical modulator, which includes a first interferometer configured to generate a first channel signal, a second interferometer configured to generate a second channel signal, and a third interferometer configured to generate a constant phase difference between the first channel signal and the second channel signal. When the control for the optical modulator is the first time, the optical signal control unit may alternately control the first interferometer and the second interferometer and then control the third interferometer. When the control for the optical modulator is not the first time, the optical signal control unit may sequentially control the first to third interferometers.

The optical signal controlling apparatus may further include: an optical signal amplifying unit configured to amplify the detected optical signal; a first signal extracting unit configured to extract a signal of a predefined first band from the amplified optical signal; a first signal processing unit configured to generate a bias signal from the extracted signal of the first band, and provide the generated bias signal as the acquisition signal; and a second signal processing unit configured to extract a signal of a second band, a frequency of which is lower than a frequency of the first band, from the amplified optical signal, and provide the extracted signal of the second band as the acquisition signal.

The time-division signal generating unit may include: a monitor signal generating unit configured to generate a monitor signal for controlling interferometers provided in an optical modulator; and a signal splitting unit configured to split the generated monitor signal into as many time-division signals as the interferometers.

The time-division signal generating unit may generate the time-division signals using a transfer curve of an optical modulator that generates the optical signal. The optical signal control unit may include: a first determining unit configured to determine whether the optical modulator is data-write-enabled; a bias value acquiring unit configured to acquire a first bias value from a bias signal selected among the generated bias signals, when the optical modulator is data-write-enabled; a second determining unit configured to determine whether the acquired first bias value is equal to a predefined target value; a first bias value generating unit configured to generate a second bias value greater than the acquired first bias value, when the acquired first bias value is not equal to the target value; a third determining unit configured to determine whether the generated second bias value is located on the left of a null position in the transfer curve; a fourth determining unit configured to increase the second bias value until the second bias value is located on the left of the null position, when the generated second bias value is not located on the left of the null position, and to determine whether the second bias value is equal to the target value, when the generated second bias value is located on the left of the null position; a second bias value generating unit configured to generate a third bias value less than the second bias value, when the second bias value is not equal to the target value; a fifth determining unit configured to determine whether the generated third bias value is located on the left of a quad-minus (quad−) position in the transfer curve; and a reference providing unit configured to decrease the third bias value until the third bias value is located on the left of the quad− position, when the generated third bias value is not located on the left of the quad− position in the transfer curve, and to provide the third bias value as a predefined reference, when the generated third bias value is located on the left of the quad− position.

According to exemplary embodiments of the present invention, since the optimal DC bias position used to control the optical modulator is automatically corrected, the DQPSK optical signal generated by the optical modulator may be optimized. The optical signal may be stably maintained, regardless of the variation in the operating temperature of the optical modulator.

A DQPSK optical transmitter is configured with a control section and a detection section of an optical modulator in order to optimally adjust the DC biases of the MZIs provided within the optical modulator. The object of the present invention is carried out through the determining process such that the control section time-divides the signals having the same frequency and the DC biases are optimized by the detection section and a processor. Accordingly, the present invention may obtain the effect that efficiently controls a plurality of MZIs within the optical modulator used for generating the DQPSK optical signal.

Furthermore, the initial operation flow and the repeating operation flow are provided as the operation steps of the control section and the detection section of the optical modulator. Accordingly, the present invention may obtain the effect that continuously maintains the DQPSK optical signal in a valid state, as well as the purpose of generating the DQPSK optical signal output from the optical modulator.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a conceptual diagram schematically illustrating an internal configuration of a DQPSK optical modulator, which generates a DQPSK optical signal.

FIG. 2 is an exemplary diagram illustrating a transfer curve of a DQPSK optical modulator, which generates a DQPSk optical signal, and a DC bias control position.

FIG. 3A and FIG. 3B is an exemplary diagram illustrating a case where a DC bias input to the DQPSK optical modulator of FIG. 1 is optimized.

FIG. 4A and FIG. 4B is an exemplary diagram illustrating a case where a DC bias input to the DQPSK optical modulator of FIG. 1 is not optimized.

FIG. 5 is a block diagram schematically illustrating an optical signal controlling apparatus according to an exemplary embodiment of the present invention.

FIG. 6 is an exemplary diagram illustrating an optical signal controlling apparatus according to an exemplary embodiment of the present invention.

FIG. 7 is an exemplary diagram illustrating driving of a control section which controls an optical modulator, according to an exemplary embodiment of the present invention.

FIG. 8 is a flowchart illustrating a preparing step of a control section and a signal detection section in the optical modulator, according to an exemplary embodiment of the present invention.

FIG. 9 is a flowchart illustrating an initial operation flow and a repeating operation flow of the control section and the signal detection section in the optical modulator, according to an exemplary embodiment of the present invention.

FIG. 10 is a flowchart illustrating an MZI optimization according to an exemplary embodiment of the present invention.

FIG. 11 is a flowchart illustrating an optical signal controlling method according to an exemplary embodiment of the present invention.

FIG. 12 is a block diagram schematically illustrating an optical signal generating device according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

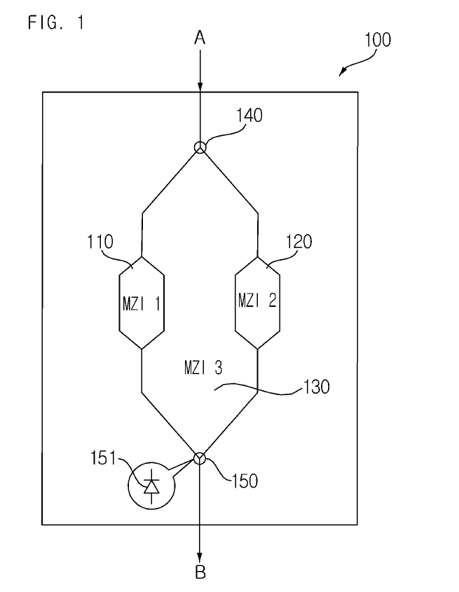

Hereinafter, exemplary embodiments of the present invention will be described in detail with reference to the accompanying drawings. First of all, we should note that in giving reference numerals to elements of each drawing, like reference numerals refer to like elements even though like elements are shown in different drawings. In describing the present invention, well-known functions or constructions will not be described in detail since they may unnecessarily obscure the understanding of the present invention. It should be understood that although exemplary embodiment of the present invention are described hereafter, the spirit of the present invention is not limited thereto and may be changed and modified in various ways by those skilled in the art. FIG. 1 is a conceptual diagram schematically illustrating an internal configuration of a DQPSK optical modulator that generates a DQPSK optical signal. A DQPSK optical modulator 100 receives a plurality of external signals and generates DQPSK optical signals based on the received external signals. In order to generate an in-phase (I) channel and a quadrature (Q) channel, a Mach-Zehnder Interferometer (MZI) 1 110 and an MZI 2 120 are connected in parallel. An MZI 3 130 is used to generate a π/2 phase difference between the I channel and the Q channel. Each of the MZI 1 110, the MZI 2 120, and the MZI 3 130 has a DC bias input port through which a DC bias is input. A CW light source A is input to an input port 140. At an output port 150, a part of the intensity of an output optical signal is branched and a DQPSK optical signal B is generated using a photo detector 151. The photo detector 151 may be implemented with an embedded photo detector (PD) provided inside the DQPSk optical modulator 100.

FIG. 2 is an exemplary diagram illustrating a transfer curve of a DQPSK optical modulator, which generates a DQPSk optical signal, and a DC bias control position. The MZI 1 and the MZI 2 for generating the I channel and the Q channel as mentioned above with reference to FIG. 1 use a ‘null’ position of the transfer curve as an optimal DC bias position, and the MZI 3 uses a ‘quad+’ or ‘quad−’ position of the transfer curve as an optimal DC bias position. As such, since MZIs have different optimal DC bias positions on the transfer curve, DC biases of all MZIs should be optimally adjusted at the same time, so as to generate DQPSK optical signals using a DQPSK optical modulator and maintain stable optical signals.

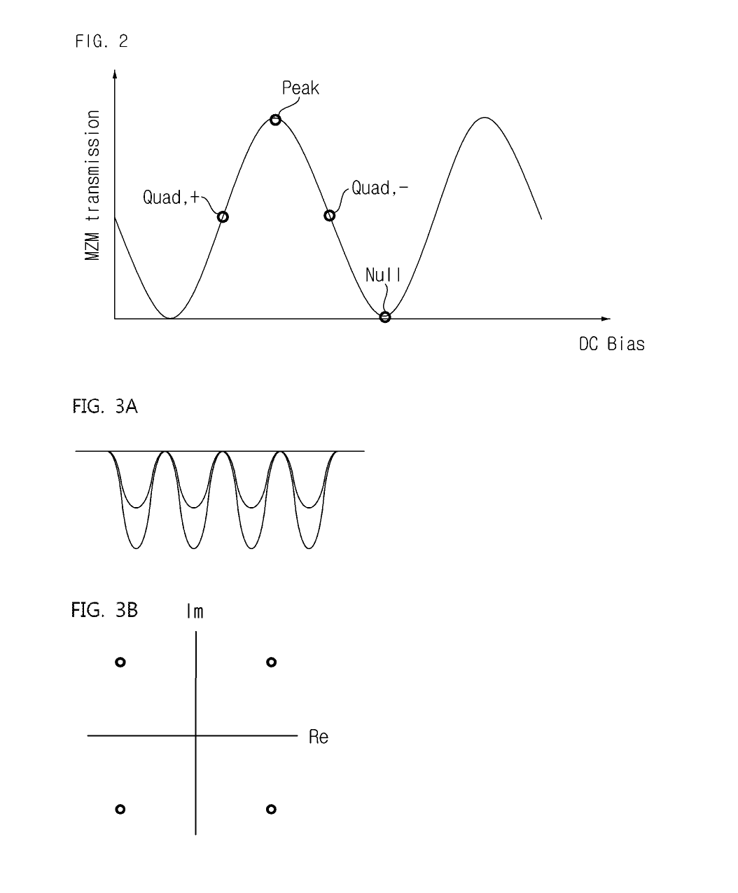

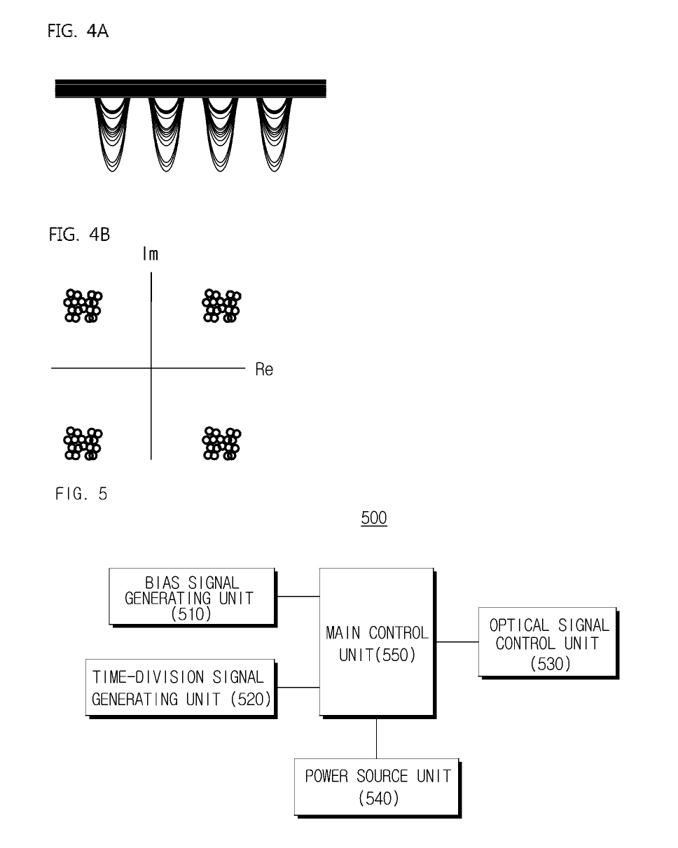

FIG. 3A and FIG. 3B is an exemplary diagram illustrating a case where a DC bias input to the DQPSK optical modulator of FIG. 1 is optimized. FIG. 3A illustrates an eye diagram of an optical signal, in which intensity eye patterns are formed, and FIG. 3B illustrates a constellation thereof. FIG. 4A and FIG. 4B is an exemplary diagram illustrating a case where a DC bias input to the DQPSk optical modulator of FIG. 1 is not optimized. As in the case of FIG. 3A and FIG. 3B, FIG. 4A illustrates an eye diagram of an optical signal, and FIG. 4B illustrates a constellation thereof. When compared with FIG. 3A and FIG. 3B, the results of FIG. 4A and FIG. 4B have a negative influence on a bit error rate (BER) when a valid signal is generated.

FIG. 5 is a block diagram schematically illustrating an optical signal controlling apparatus according to an exemplary embodiment of the present invention. Referring to FIG. 5, the optical signal controlling apparatus 500 includes a bias signal generating unit 510, a time-division signal generating unit 520, an optical signal control unit 530, a power source unit 540, and a main control unit 550.

The optical signal controlling apparatus 500 is an apparatus for controlling a DQPSK optical modulator and is a controlling apparatus for DC bias control optimization of an optical modulator that generates a DQPSK optical signal.

The bias signal generating unit 510 functions to generate bias signals, which comply with a predefined reference, by using an acquisition signal acquired from a detected optical signal. In the exemplary embodiment, the bias signal generating unit 510 may be implemented with a DC bias controller.

The time-division signal generating unit 520 functions to generate as many time-division signals as the generated bias signals. In the exemplary embodiment, the time-division signal generating unit 520 may be implemented with an oscillator and a gate.

The time-division signal generating unit 520 may include a monitor signal generating unit and a signal splitting unit. The monitor signal generating unit functions to generate a monitor signal for controlling interferometers provided in the optical modulator. The signal splitting unit functions to split the generated monitor signal into as many time-division signals as the interferometers. In the exemplary embodiment, the monitor signal generating unit may be implemented with an oscillator, and the signal splitting unit may be implemented with a gate.

When generating the time-division signals, the time-division signal generating unit 520 may use a transfer curve of the optical modulator that generates the optical signal.

The optical signal control unit 530 functions to combine the mutually corresponding bias signals and time-division signals among the generated bias signals and the generated time-division signals, respectively, change a phase value using the combined signals, and control an optical signal to be output. In the exemplary embodiment, the optical signal control unit 530 may be implemented with a processor or an adder.

The optical signal control unit 530 may control the optical signal by controlling the optical modulator. The optical modulator may include a first interferometer configured to generate a first channel signal, a second interferometer configured to generate a second channel signal, and a third interferometer configured to generate a constant phase difference between the first channel signal and the second channel signal. In this case, when the control for the optical modulator is the first time, the optical signal control unit 530 alternately controls the first interferometer and the second interferometer and then controls the third interferometer. When the control for the optical modulator is not the first time, the optical signal control unit 530 sequentially controls the first to third interferometers.

When the time-division signal generating unit 520 generates the time-division signals using the transfer curve of the optical modulator, the optical signal control unit 530 may include a first determining unit, a bias value acquiring unit, a second determining unit, a first bias value generating unit, a third determining unit, a fourth determining unit, a second bias value generating unit, a fifth determining unit, and a reference providing unit. The first determining unit functions to determine whether the optical modulator is data-write-enabled. When the optical modulator is data-write-enabled, the bias value acquiring unit functions to acquire a first bias value from a bias signal selected among the generated bias signals. The second determining unit functions to determine whether the acquired first bias value is equal to a predefined target value. In the exemplary embodiment, the target value is a condition for controlling the optical modulator to generate a constant optical signal by correcting a temperature change that occurs whenever the optical modulator operates. For example, the target value may be a DC bias value to be input to the interferometers provided in the optical modulator. When the acquired first bias value is not equal to the target value, the first bias value generating unit functions to generate a second bias value greater than the acquired first bias value. The third determining unit functions to determine whether the generated second bias value is located on the left of a null position in the transfer curve. When the generated second bias value is not located on the left of the null position, the fourth determining unit functions to increase the second bias value until the second bias value is located on the left of the null position. When the generated second bias value is located on the left of the null position, the fourth determining unit functions to determine whether the second bias value is equal to the target value. When the second bias value is not equal to the target value, the second bias value generating unit functions to generate a third bias value less than the second bias value. The fifth determining unit functions to determine whether the generated third bias value is located on the left of a quad-minus (quad−) position in the transfer curve. When the generated third bias value is not located on the left of the quad− position in the transfer curve, the reference providing unit functions to decrease the third bias value until the third bias value is located on the left of the quad− position. When the generated third bias value is located on the left of the quad− position, the reference providing unit functions to provide the third bias value as a predefined reference. When the optical modulator is data-write-disabled, the optical signal control unit 530 performs no functions if the first bias value or the second bias value is equal to the target value.

The power source unit 540 functions to supply power to the respective units constituting the optical signal controlling apparatus 500.

The main control unit 550 functions to control the overall operations of the respective units constituting the optical signal controlling apparatus 500.

The optical signal controlling apparatus 500 may further include an optical signal amplifying unit, a first signal extracting unit, a first signal processing unit, and a second signal processing unit. The optical signal amplifying unit functions to amplify a detected optical signal. In the exemplary embodiment, the optical signal amplifying unit may be implemented with an amplifier. The first signal extracting unit functions to extract a signal of a predefined first band from the amplified optical signal. In the exemplary embodiment, the first signal extracting unit may be implemented with a band pass filter (BPF). The first signal processing unit functions to generate a bias signal from the extracted signal of the first band, and provide the generated bias signal as the acquisition signal. In the exemplary embodiment, the first signal processing unit may be implemented with an RMS-to-DC converter. The second signal processing unit functions to extract a signal of a second band, a frequency of which is lower than that of the first band, from the amplified optical signal, and provide the extracted signal of the second band as the acquisition signal. In the exemplary embodiment, the second signal processing unit may be implemented with a low pass filter (LPF).

The optical signal controlling apparatus 500 is designed to automatically optimize a DC bias operating point of the optical modulator. The optical signal controlling apparatus 500 functions to automatically correct an optimal DC bias position of the optical modulator in order to prevent performance degradation of a transmission system, which may be caused by the transfer curve characteristic change with respect to the operating temperature change of the optical modulator for generating the DQPSK optical signal. Hereinafter, an exemplary embodiment of the optical signal controlling apparatus 500 will be described.

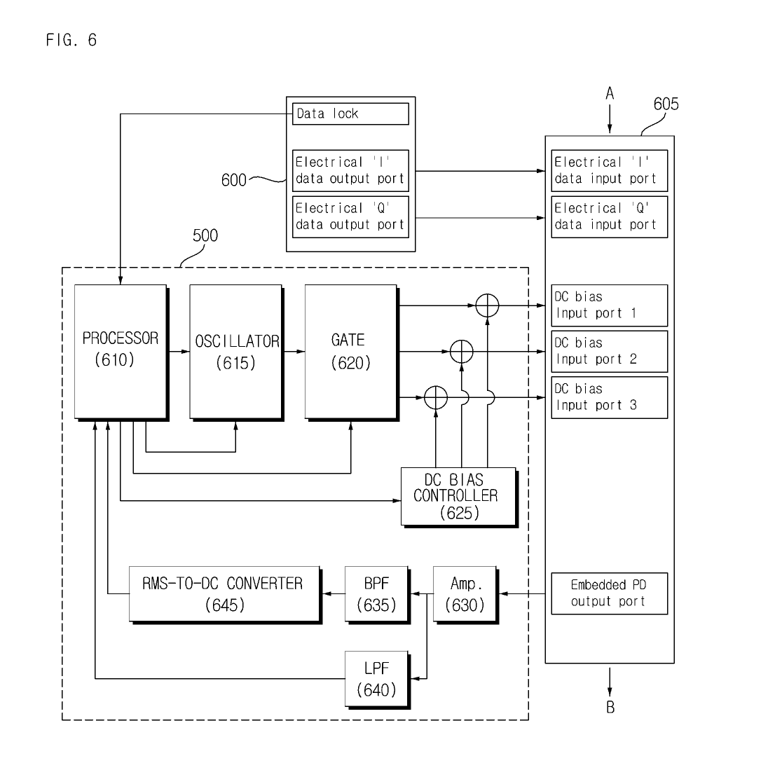

FIG. 6 is an exemplary diagram of an optical signal controlling apparatus according to an exemplary embodiment of the present invention. As illustrated in FIG. 6, the optical signal controlling apparatus 500 may include a control section and a detection section of a DQPSK optical modulator.

An external light source is input (A: CW (Continuous wave) light source in), and an I (In-phase) channel and a Q (Quadrature) channel are generated from a data generator 600 and are input to a DQPSK optical modulator 605 for generating a DQPSK optical signal. Since the optical signal controlling apparatus 500 is configured to provide an automatic DC bias optimization method of the optical modulator, the optical signal controlling apparatus 500 performs a control for a smooth operation of the optical modulator. Accordingly, the optical modulator 605 generates and outputs a DQPSK optical signal (B: DQPSK optical signal out).

In FIG. 6, a section indicated by dotted lines is divided into a control section and a signal detection section so as to provide an automatic DC bias optimization method of the optical modulator. The control section includes a processor 610, an oscillator 615, a gate 620, and a DC bias controller 625. The processor 610 controls the oscillator 615, the gate 620, and the DC bias controller 625. The signal detection section includes an amplifier 630, a BPF 635, an LPF 640, and an RMS-to-DC converter 645. A signal output from an embedded photo detector of the optical modulator passes through the amplifier 630, the BPF 635, the LPF 640, and the RMS-to-DC converter 645 and is then processed by the processor 610. An output signal of the oscillator 615 is a low-frequency signal that has a frequency of several kHz and does not influence the optical signal due to the frequency characteristic. The output signal of the oscillator 615 is used as a monitor signal in order for the processor 610 to control the MZIs of the optical modulator 605 to have the optimal DC biases at the same time.

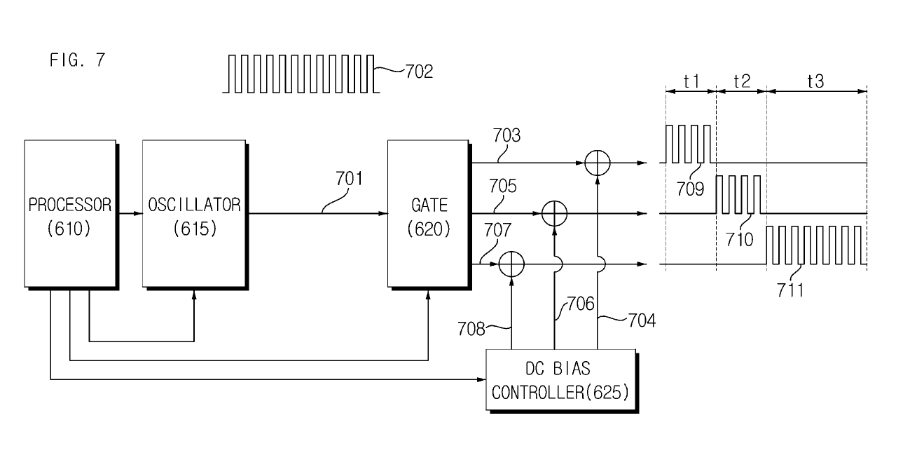

In the exemplary embodiment, in order to generate the DQPSK optical signals using the optical modulator and stably maintain the optical signals, three MZIs should be controlled to be the optimal DC biases at the same time. FIG. 7 is an exemplary diagram illustrating a driving of the control section which controls the optical modulator, according to an exemplary embodiment of the present invention. The processor 610 generates DC biases at three output ports 704, 706 and 708 of the DC bias controller 625. The processor 610 generates a monitor signal 702 to the output port 701 of the oscillator 615. The processor 610 generates time-division signals to three output ports 703, 705 and 707 through the gate 620 having one input port and three output ports. As a result, the monitor signal 702 is time-divided and combined with the outputs of the DC bias controller 625 to generate combined signals 709, 710 and 711.

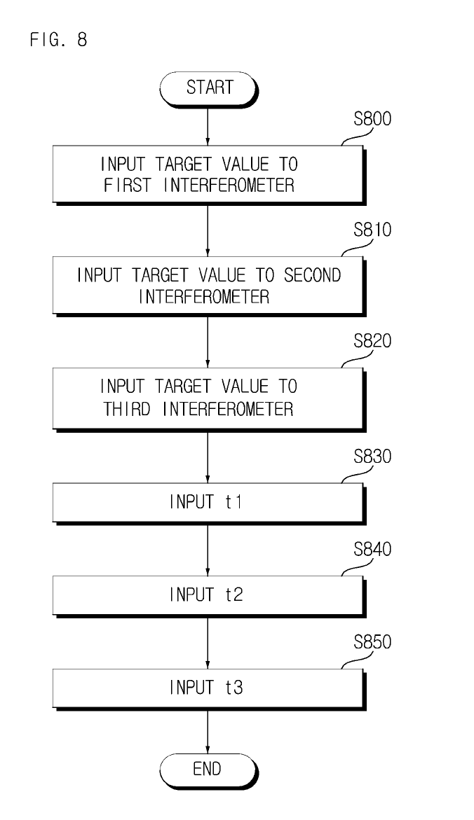

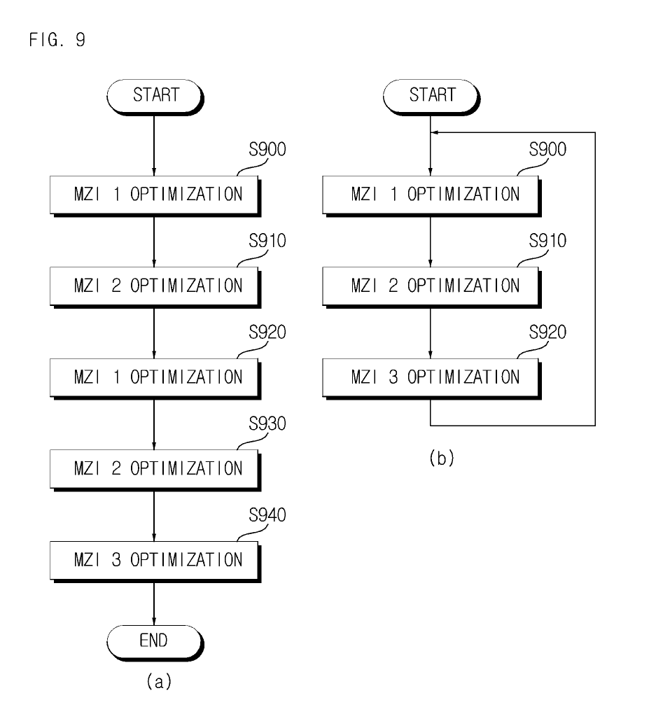

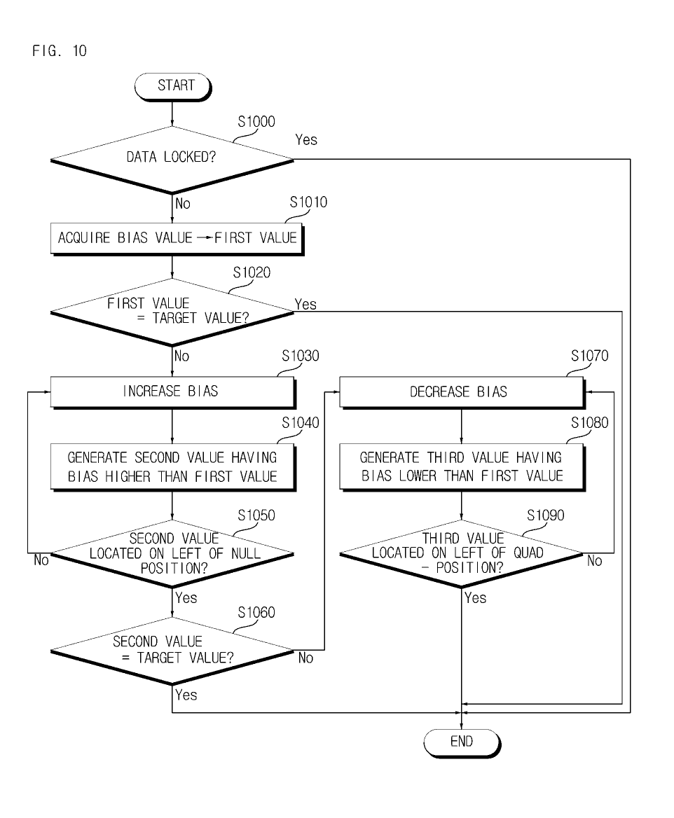

Accordingly, DC components and AC components are input to DC bias input ports 1, 2 and 3 of the optical modulator of FIG. 6. Time t1, time t2 and time t3 are used as time for controlling the MZI 1, time for controlling the MZI 2, and time for controlling the MZI 3, respectively. FIG. 8 is a flowchart illustrating a preparing step of the control section and the signal detection section in the optical modulator according to an exemplary embodiment of the present invention. In steps S800 to S820, target values are input using the signal detection section in order to control the MZI 1, the MZI 2, and the MZI 3. In steps S830 to S850, control times t1, t2 and t3 are input. More specifically, in step S800, the target value is input to the first interferometer obtained from the signal having passed through the LPF 640 and the signal having passed through the RMS-to-DC converter 645. In step S810, the target value is input to the second interferometer obtained from the signal having passed through the LPF 640 and the signal having passed through the RMS-to-DC converter 645. In step S820, the target value is input to the third interferometer obtained from the signal having passed through the LPF 640 and the signal having passed through the RMS-to-DC converter 645. In the exemplary embodiment, the first interferometer is configured to generate the I channel, and the second interferometer is configured to generate the Q channel. The third interferometer is configured to generate a constant phase difference between the I channel and the Q channel. In step S830, the time t1 is input. The time t1 refers to time for supplying a DC bias to the first interferometer. Likewise, in steps S840 and S850, the time t2 and the time t3 are input. The time t2 refers to time for supplying a DC bias to the second interferometer, and the time t3 refers to time for supplying a DC bias to the third interferometer. FIG. 9 is a flowchart illustrating an initial operation flow and a repeating operation flow of the control section and the signal detection section of the optical modulator, according to an exemplary embodiment of the present invention. FIG. 9(a) illustrates an exemplary embodiment of the initial operation flow, and FIG. 9(b) illustrates an exemplary embodiment of the repeating operation flow. The initial operation flow is provided to input power to the respective elements of the control section and the signal detection section and initially generate DQPSk optical signals as the outputs of the optical modulator. The repeating operation flow is provided to continuously maintain the initially generated DQPSK optical signals. The initial operation flow is performed in the following order: MZI 1 optimization (DC bias input port 1 optimization) (S900)→MZI 2 optimization (DC bias input port 2 optimization) (S910)→MZI 1 optimization (S920)→MZI 2 optimization (S930)→MZI 3 optimization (DC bias input port 3 optimization) (S940). The repeating operation flow continuously repeats the following operations: MZI 1 optimization (DC bias input port 1 optimization) (S900)→MZI 2 optimization (DC bias input port 2 optimization) (S910)→MZI 3 optimization (DC bias input port 3 optimization) (S920).

FIG. 10 is a flowchart illustrating an MZI optimization according to an exemplary embodiment of the present invention. The exemplary embodiment of FIG. 10 may be applied when the MZIs are optimized in FIG. 9. The MZI optimization of FIG. 10 is continuously repeated within the flow from the start to the stop during the time previously input through the processes of FIG. 8 until the DC bias value is equal to the target value.

The optimization of the optical modulator should be suitable for outputting data, which is actually input to the optical modulator, through a normal generating process and should be suitable for using the generated data. Therefore, it is determined whether data is locked in FIG. 6 under the initial operation condition. The optical modulator needs to determine whether a current control position is located on the right or left of a null position, like in the transfer curve characteristic. In addition, the optical modulator needs to determine whether the current control position is located at an upper or lower position around the quad+ position and needs to determine whether the current control position is located at an upper or lower position around the quad− position. After the determination of the data lock, signals are generated, adjusted and detected through the elements of the control section and the signal detection section so that the DC bias value becomes equal to the target value of FIG. 8. The processor determines the above process and adjusts the outputs of the DC bias controller. A further detailed description will be made with reference to FIG. 10. In the following description, a case of optimizing the MZI 1 will be exemplified.

First, it is determined whether the optical modulator is data-write-enabled (read ‘Tx, lock error’?) (S1000). When the optical modulator is data-write-enabled, a bias value to be supplied to the MZI 1 is acquired and stored as a first value (S1010). Then, it is determined whether the first value is equal to a predefined target value (S1020). When the first value is not equal to the target value, a second value having a bias higher than that of the first value is generated (S1030). Then, the second value is stored (S1040). Then, it is determined whether the second value is located on the left of the null position in the transfer curve (S1050). When the second value is not located on the left of the null position, the second value is increased until the second value is located on the left of the null position. When the second value is located on the left of the null position, it is determined whether the second value is equal to the target value (S1060). When the second value is not equal to the target value, a third value less than the second value is generated (S1070). Then, the third value is stored (S1080). It is determined whether the third value is located on the left of the quad− position in the transfer curve (S1090). When the third value is not located on the left of the quad− position in the transfer curve, the third value is decreased until the third value is located on the left of the quad− position. When the third value is located on the left of the quad− position, the third value is provided as the target value.

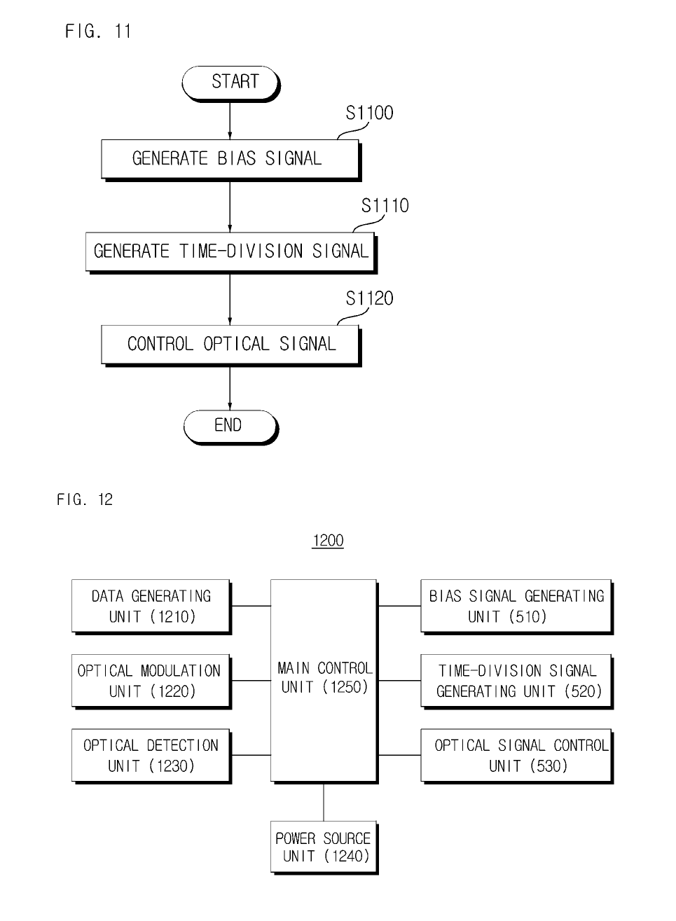

Next, an optical signal controlling method of the optical signal controlling apparatus 500 will be described below. FIG. 11 is a flowchart illustrating an optical signal controlling method according to an exemplary embodiment of the present invention. The following description will be made with reference to FIG. 11.

First, bias signals complying with a predefined reference are generated using the acquisition signal acquired from the detected optical signal (bias signal generating step (S1100)).

Then, as many time-division signals as the generated bias signals are generated (time-division signal generating step (S1110)). The time-division signal generating step (S1110) may include a monitor signal generating step and a signal splitting step. The monitor signal generating step is a step for generating a monitor signal for controlling the interferometers provided in the optical modulator. The signal splitting step is a step for splitting the generated monitor signal into as many time-division signals as the interferometers. When the time-division signals are generated, the time-division signal generating step (S1110) uses the transfer curve of the optical modulator that generates the optical signal.

Then, the mutually corresponding bias signals and time-division signals among the generated bias signals and the generated time-division signals are combined, respectively, and the optical signal to be output is controlled by changing a phase value using the combined signals (optical signal controlling step (S1120)).

In the optical signal controlling step (S1120), the optical signal may be controlled by controlling the optical modulator. The optical modulator may include a first interferometer configured to generate a first channel signal, a second interferometer configured to generate a second channel signal, and a third interferometer configured to generate a constant phase difference between the first channel signal and the second channel signal. In this case, when the control for the optical modulator is the first time, the optical signal controlling step (S1120) includes alternately controlling the first interferometer and the second interferometer and then controlling the third interferometer. When the control for the optical modulator is not the first time, the optical signal controlling step (S1120) includes sequentially controlling the first to third interferometers. When the control for the optical modulator is the first time, the optical signal controlling step (S1120) may include controlling the third interferometer after optimizing both the first interferometer and the second interferometer.

In a case the transfer curve of the optical modulator is used when the time-division signals are generated in the time-division signal generating step (S1110), the optical signal controlling step (S1120) may include a first determining step, a bias value acquiring step, a second determining step, a first bias value generating step, a third determining step, a fourth determining step, a second bias value generating step, a fifth determining step, and a reference providing step. The first determining step is a step for determining whether the optical modulator is data-write-enabled. The bias value acquiring step is a step for acquiring a first bias value from a bias signal selected among the generated bias signals when the optical modulator is data-write-enabled. The second determining step is a step for determining whether the acquired first bias value is equal to a predefined target value. The first bias value generating step is a step for generating a second bias value greater than the acquired first bias value when the acquired first bias value is not equal to the target value. The third determining step is a step for determining whether the generated second bias value is located on the left of a null position in the transfer curve. The fourth determining step is a step for increasing the second bias value until the second bias value is located on the left of the null position, when the generated second bias value is not located on the left of the null position, and determining whether the second bias value is equal to the target value, when the generated second bias value is located on the left of the null position. The second bias value generating step is a step for generating a third bias value less than the second bias value, when the second bias value is not equal to the target value. The fifth determining step is a step for determining whether the generated third bias value is located on the left of a quad− position in the transfer curve. The reference providing step is a step for decreasing the third bias value until the third bias value is located on the left of the quad− position, when the generated third bias value is not located on the left of the quad− position in the transfer curve, and providing the third bias value as a predefined reference, when the generated third bias value is located on the left of the quad− position.

In the exemplary embodiment, an optical signal amplifying step, a first signal extracting step, a first signal processing step, and a second signal processing step may be performed before the bias signal generating step (S1100). The optical signal amplifying step is a step for amplifying a detected optical signal. The first signal extracting step is a step for extracting a signal of a predefined first band from the amplified optical signal. The first signal processing step is a step for generating a bias signal from the extracted signal of the first band, and providing the generated bias signal as the acquisition signal. The second signal processing step is a step for extracting a signal of a second band, whose frequency is lower than that of the first band, from the amplified optical signal, and providing the extracted signal of the second band as the acquisition signal.

Next, an optical signal generating device including the optical signal controlling apparatus will be described. FIG. 12 is a block diagram schematically illustrating an optical signal generating device according to an exemplary embodiment of the present invention. Referring to FIG. 12, the optical signal generating device 1200 includes a data generating unit 1210, an optical modulation unit 1220, an optical detection unit 1230, a bias signal generating unit 510, a time-division signal generating unit 520, an optical signal control unit 530, a power source unit 1240, and a main control unit 1250.

The data generating unit 1210 functions to generate a third channel signal and a fourth channel signal. The third channel signal represents an I channel signal, and the fourth channel signal represents a Q channel signal. In the exemplary embodiment, the data generating unit 1210 may be implemented with a data generator.

The optical modulation unit 1220 functions to generate an optical signal for incident light, considering the generated third channel signal and the generated fourth channel signal, and output the generated optical signal to the exterior. The optical modulation unit 1220 interworks with the optical signal control unit 530 to generate and output a DQPSK optical signal. In the exemplary embodiment, the optical modulation unit 1220 may be implemented with an optical modulator.

The optical detection unit 1230 is provided in the optical modulation unit 1220 and functions to detect the generated optical signal. In the exemplary embodiment, the optical detection unit 1230 may be implemented with an embedded photodiode of the optical modulator.

The bias signal generating unit 510 functions to generate bias signals complying with a predefined reference by using an acquisition signal that is acquired from the optical signal detected by the optical detection unit 1230.

The time-division signal generating unit 520 functions to generate as many time-division signals as the generated bias signals.

The optical signal control unit 530 functions to combine the mutually corresponding bias signals and time-division signals among the generated bias signals and the generated time-division signals, respectively, change a phase value using the combined signals, and control an optical signal to be output.

The power source unit 1240 functions to supply power to the respective units of the optical signal generating device 1200. In the exemplary embodiment, in order to distinguish the power source unit 540 from the power source unit 1240, the former may be defined as a first power source unit 540, and the latter may be defined as a second power source unit 1240.

The main control unit 1250 functions to control the overall operations of the respective units constituting the optical signal generating device 1200. As in the case of the power source unit, in the exemplary embodiment, the main control unit 550 of FIG. 5 and the main control unit 1250 of FIG. 12 may be defined as a first main control unit and a second main control unit, respectively, so as to distinguish the two main control units.

In addition to the above-described configurations, the optical signal generating device 1200 may further include the configuration of the optical signal controlling apparatus 500 described above with reference to FIG. 5.

A control section and a signal detection section of an optical modulator are provided for controlling two interferometers (MZI1 and MZI 2) and a phase shifter (MZI 3) of an optical modulator. The signal detection section detects signals having the same frequency, and the control section of the optical modulator time-divides the detected signal so that a DC bias is optimally adjusted. In addition, a process is divided into an initial operation flow and a repeating operation flow so as to further improve the control efficiency of the optical modulator. An initial state control of the optical modulator and a state control during operations are performed through the respective flows. An optimal DC bias position used to control the optimal modulator is automatically corrected. Accordingly, a DQPSK optical signal generated by the optical modulator is optimized. The optical signal is stably maintained, regardless of a variation in the operating temperature of the optimal modulator.

The present invention relates to an apparatus and a method for controlling a DQPSK optical modulator and is applicable to the fields of Ethernet or the fields of optical transmission technology.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. An optical signal controlling apparatus, comprising:
a bias signal generating unit configured to generate bias signals complying with a predefined reference by using an acquisition signal acquired from a detected optical signal;
a time-division signal generating unit configured to generate as many time-division signals as the generated bias signals; and
an optical signal control unit configured to combine the mutually corresponding bias signals and time-division signals among the generated bias signals and the generated time-division signals, respectively, change a phase value using the combined signals, and control an optical signal to be output.

2. The optical signal controlling apparatus of claim 1, wherein the optical signal control unit controls the optical signal by controlling an optical modulator, which includes a first interferometer configured to generate a first channel signal, a second interferometer configured to generate a second channel signal, and a third interferometer configured to generate a constant phase difference between the first channel signal and the second channel signal; when the control for the optical modulator is the first time, the optical signal control unit alternately controls the first interferometer and the second interferometer and then controls the third interferometer; and when the control for the optical modulator is not the first time, the optical signal control unit sequentially controls the first to third interferometers.

3. The optical signal controlling apparatus of claim 1, further comprising:
an optical signal amplifying unit configured to amplify the detected optical signal;
a first signal extracting unit configured to extract a signal of a predefined first band from the amplified optical signal;
a first signal processing unit configured to generate a bias signal from the extracted signal of the first band, and provide the generated bias signal as the acquisition signal; and
a second signal processing unit configured to extract a signal of a second band, a frequency of which is lower than a frequency of the first band, from the amplified optical signal, and provide the extracted signal of the second band as the acquisition signal.

4. The optical signal controlling apparatus of claim 1, wherein the time-division signal generating unit comprises:
a monitor signal generating unit configured to generate a monitor signal for controlling interferometers provided in an optical modulator; and
a signal splitting unit configured to split the generated monitor signal into as many time-division signals as the interferometers.

5. The optical signal controlling apparatus of claim 1, wherein the time-division signal generating unit generates the time-division signals using a transfer curve of an optical modulator that generates the optical signal.

6. The optical signal controlling apparatus of claim 5, wherein the optical signal control unit comprises:
a first determining unit configured to determine whether the optical modulator is data-write-enabled;
a bias value acquiring unit configured to acquire a first bias value from a bias signal selected among the generated bias signals, when the optical modulator is data-write-enabled;
a second determining unit configured to determine whether the acquired first bias value is equal to a predefined target value;
a first bias value generating unit configured to generate a second bias value greater than the acquired first bias value, when the acquired first bias value is not equal to the target value;
a third determining unit configured to determine whether the generated second bias value is located on the left of a null position in the transfer curve;
a fourth determining unit configured to increase the second bias value until the second bias value is located on the left of the null position, when the generated second bias value is not located on the left of the null position, and to determine whether the second bias value is equal to the target value, when the generated second bias value is located on the left of the null position;
a second bias value generating unit configured to generate a third bias value less than the second bias value, when the second bias value is not equal to the target value;
a fifth determining unit configured to determine whether the generated third bias value is located on the left of a quad-minus (quad−) position in the transfer curve; and
a reference providing unit configured to decrease the third bias value until the third bias value is located on the left of the quad− position, when the generated third bias value is not located on the left of the quad− position in the transfer curve, and to provide the third bias value as a predefined reference, when the generated third bias value is located on the left of the quad− position.

7. An optical signal controlling method, comprising:
a bias signal generating step for generating bias signals complying with a predefined reference using an acquisition signal acquired from a detected optical signal;
a time-division signal generating step for generating as many time-division signals as the generated bias signals; and
an optical signal controlling step for combining the mutually corresponding bias signals and time-division signals among the generated bias signals and the generated time-division signals, changing a phase value using the combined signals, and controlling an optical signal to be output.

8. The optical signal controlling method of claim 7, wherein the optical signal controlling step comprises controlling the optical signal by controlling an optical modulator, which includes a first interferometer configured to generate a first channel signal, a second interferometer configured to generate a second channel signal, and a third interferometer configured to generate a constant phase difference between the first channel signal and the second channel signal; when the control for the optical modulator is the first time, the optical signal controlling step comprises alternately controlling the first interferometer and the second interferometer and then controlling the third interferometer; and when the control for the optical modulator is not the first time, the optical signal controlling step comprises sequentially controlling the first to third interferometers.

9. The optical signal controlling method of claim 7, further comprising:
an optical signal amplifying step for amplifying a detected optical signal;
a first signal extracting step for extracting a signal of a predefined first band from the amplified optical signal;
a first signal processing step for generating a bias signal from the extracted signal of the first band, and providing the generated bias signal as the acquisition signal; and
a second signal processing step for extracting a signal of a second band, a frequency of which is lower than a frequency of the first band, from the amplified optical signal, and providing the extracted signal of the second band as the acquisition signal.

10. The optical signal controlling method of claim 7, wherein the time-division signal generating step comprises:
a monitor signal generating step for generating a monitor signal for controlling interferometers provided in an optical modulator; and
a signal splitting step for splitting the generated monitor signal into as many time-division signals as the interferometers.

11. The optical signal controlling method of claim 7, wherein in the time-division signal generating step, the time-division signals are generated using a transfer curve of an optical modulator that generates an optical signal.

12. The optical signal controlling method of claim 11, wherein the optical signal controlling step comprises:
a first determining step for determining whether the optical modulator is data-write-enabled;
a bias value acquiring step for acquiring a first bias value from a bias signal selected among the generated bias signals, when the optical modulator is data-write-enabled;
a second determining step for determining whether the acquired first bias value is equal to a predefined target value;
a first bias value generating step for generating a second bias value greater than the acquired first bias value, when the acquired first bias value is not equal to the target value;
a third determining step for determining whether the generated second bias value is located on the left of a null position in the transfer curve;
a fourth determining step for increasing the second bias value until the second bias value is located on the left of the null position, when the generated second bias value is not located on the left of the null position, and determining whether the second bias value is equal to the target value, when the generated second bias value is located on the left of the null position;
a second bias value generating step for generating a third bias value less than the second bias value, when the second bias value is not equal to the target value; a fifth determining step for determining whether the generated third bias value is located on the left of a quad-minus (quad−) position in the transfer curve; and
a reference providing step for decreasing the third bias value until the third bias value is located on the left of the quad− position, when the generated third bias value is not located on the left of the quad− position in the transfer curve, and providing the third bias value as a predefined reference, when the generated third bias value is located on the left of the quad− position.

13. An optical signal generating device, comprising:
a data generating unit configured to generate a third channel signal and a fourth channel signal;
an optical modulation unit configured to generate an optical signal for incident light, considering the generated third channel signal and the generated fourth channel signal, and to output the generated optical signal to the exterior;
an optical detection unit provided in the optical modulation unit and configured to detect the generated optical signal;
a bias signal generating unit configured to generate bias signals complying with a predefined reference by using an acquisition signal that is acquired from the detected optical signal;
a time-division signal generating unit configured to generate as many time-division signals as the generated bias signals; and
an optical signal control unit configured to combine the mutually corresponding bias signals and time-division signals among the generated bias signals and the generated time-division signals, respectively, change a phase value using the combined signals, and control an optical signal to be output.

14. The optical signal generating device of claim 13, wherein the optical modulation unit interworks with the optical signal control unit to generate and output a Differential Quadrature Phase Shift Keying (DQPSK) optical signal.
